(19) United States
(12) Patent Application Publication
(10) Pub. No.: US 2025/0211543 A1
(43) Pub. Date: Jun. 26, 2025

(54) METHODS FOR REDUCING PACKET LOSS DURING SLOW START STAGE OF A SESSION

(71) Applicant: Pismo Labs Technology Limited, Kowloon (HK)

(72) Inventor: Wan Chun LEUNG, Kowloon (HK)

(73) Assignee: Pismo Labs Technology Limited, Kowloon (HK)

(21) Appl. No.: 18/848,756

(22) PCT Filed: Dec. 29, 2022
(86) PCT No.: PCT/IB2022/062856

§ 371 Date: Sep. 19, 2024

(51) Int. Cl. H04L 47/10; H04L 45/24; H04L 47/34

(52) U.S. Cl. CPC H04L 47/37; H04L 45/24; H04L 47/34

(57) ABSTRACT

The present invention discloses a system and method for transmitting data packets at a network device. The network device of the system may select a first connection according to a first selection policy and select at least one second connection according to the second selection policy respectively if a data packet belonging to a new session is received. After the selection, network device may transmit each of original encapsulating packets (OEPs) through the first connection, and transmit each of at least one duplicate encapsulating packets (DEPs) through the at least one second connection within a specific period of time during a slow start stage. After the slow start stage, network device may transmit OEP only through a third connection, and no longer transmit the at least one DEP.

### TECHNICAL FIELD

This disclosure relates generally to mobile wireless networking, and specifically to a system and method for using mobile wireless network information to modify network protocol performance.

### BACKGROUND ART

The connectivity of wireless connections is unpredictable, and the problem of packet loss occurs frequently. Transmission Control Protocol (TCP) design considers packet loss to be the result of network congestion. To prevent network congestion, a series of congestion control algorithms are introduced, including slow start stage and congestion avoidance stage. According to the algorithms, the congestion window will be increased exponentially during the slow start stage. When packet loss occurs, the congestion control process moves to the congestion avoidance stage and the congestion window will be increased linearly instead of exponentially. To perform TCP acceleration, the present invention applies a solution for utilizing multiple tunnels to increase the probability of successful transmission of data at the beginning of the establishment of a TCP session, which may be achieved by using duplicate packets.

A large chance of packet loss may thereby be avoided, and the exponentially-increased duration can be maximized.

### SUMMARY OF INVENTION

The present invention discloses methods and systems of transmitting data packets at a network device. According to the disclosure of the present invention, the network device determines if a data packet received belongs to a new session. When the data packet belongs to a new session the network device selects a first connection according to a first selection policy and at least one second connection according to a second selection policy. After that, the network device transmits original encapsulating packets (OEPs) through the first connection. The network device also transmits at least one duplicate encapsulating packets (DEPs) corresponding to each of the DEPs through at least one second connection until a specific period of time is reached. When the specific period of time is reached, each of OEPs is transmitted through a third connection, and the transmission of the at least one DEPs is stopped.

The data packet received by the network device of the present invention may be initially originated from a host connected to the network device. In one implementation of the present invention, the specific period of time may be a period of time within a slow start stage of a TCP data session establishment phase.

There is no limitation on the number of DEPs transmitted for each of the OEPs. Similarly, there is no limitation on the number of connections used by the network device to transmit the DEPs. In one variant, the OEPs and the DEPs are transmitted through an aggregated connection.

### BRIEF DESCRIPTION OF DRAWINGS

FIG. 1 is a schematic block diagram of an exemplary network device 100 according to the embodiments of the present invention.

FIG. 2 is the network diagram according to various embodiments of the present invention.

FIG. 3 is a network diagram illustrating the tunnels established between network devices according to various embodiments of the present invention.

FIG. 4 is the process flow diagram illustrating processes performed at the network device during the slow start stage according to the embodiment of the present invention.

FIG. 5A shows the relationship between the size of the congestion window versus time for transmitting data packets of a TCP session according to a conventional congestion control process implementation.

FIG. 5B shows the relationship between the size of the congestion window versus time for transmitting data packets of a TCP session according to the present congestion control process implementation.

FIG. 6A illustrates the structure of an OEP according to various embodiments of the present invention.

FIG. 6B illustrates the structure of a DEP according to various embodiments of the present invention.

### DESCRIPTION OF EMBODIMENTS

The present invention provides the systems and methods for reducing packet loss during a slow start stage to improve network performance, which advantageously addresses the needs identified above.

The ensuing description provides only preferred exemplary embodiment(s) and exemplary embodiments and is not intended to limit the scope, applicability, or configuration of the invention. Rather, the ensuing description of the preferred exemplary embodiment(s) and exemplary embodiments will provide those skilled in the art with an enabling description for implementing a preferred exemplary embodiment of the invention. It is understood that various changes may be made in the function and arrangement of elements without departing from the spirit and scope of the invention as set forth in the appended claims.

A processing unit executes program instructions or code segments for implementing embodiments of the present invention. Furthermore, embodiments may be implemented by hardware, software, firmware, middleware, microcode, hardware description languages, or any combination thereof. When implemented in software, firmware, middleware or microcode, the program instructions to perform the necessary tasks may be stored in a non-transitory computer readable storage medium. A processing unit(s) may be realized by virtualization, and maybe a virtual processing unit(s) including a virtual processing unit in a cloud-based instance.

The program instructions making up the various embodiments may be stored in a storage medium. Moreover, as disclosed herein, the term “computer-readable storage medium” may represent one or more devices for storing data, including read-only memory (ROM), programmable read-only memory (PROM), erasable programmable read-only memory (EPROM), random access memory (RAM), magnetic RAM, core memory, floppy disk, flexible disk, hard disk, magnetic tape, CD-ROM, flash memory devices, a memory card and/or other machine-readable mediums for storing information. The term “computer-readable storage medium” may also include, but is not limited to portable or fixed storage devices, optical storage mediums, magnetic mediums, memory chips or cartridges, wireless channels and various other mediums capable of storing, containing or carrying instruction(s) and/or data. A computer-readable storage medium may be realized by virtualization, and maybe a virtual computer-readable storage medium including a virtual computer-readable storage medium in a cloud-based instance.

Embodiments of the present invention are related to the use of a computer system for implementing the techniques described herein. In an embodiment, the inventive processing units may reside on a machine such as a computer platform. According to one embodiment of the invention, the techniques described herein are performed by a computer system in response to the processing unit executing one or more sequences of one or more instructions contained in the volatile memory. Such instructions may be read into the volatile memory from another computer-readable medium. Execution of the sequences of instructions contained in the volatile memory causes the processing unit to perform the process steps described herein. In alternative embodiments, hardwired circuitry may be used in place of or in combination with software instructions to implement the invention. Thus, embodiments of the invention are not limited to any specific combination of hardware circuitry and software.

Also, it is noted that the embodiments may be described as a process which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Moreover, as disclosed herein, the term “secondary storage” and “main memory” may represent one or more devices for storing data, including ROM, RAM, magnetic RAM, core memory, magnetic disk storage mediums, optical storage mediums, flash memory devices and/or other machine-readable mediums for storing information. The term “machine-readable medium” includes, but is not limited to portable or fixed storage devices, optical storage devices, wireless channels and various other mediums capable of storing, containing, or carrying instruction(s) and/or data. A machine-readable medium may be realized by virtualization, and may be a virtual machine-readable medium including a virtual machine-readable medium in a cloud-based instance.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine-readable medium such as storage medium. A processing unit(s) may perform the necessary tasks. A processing unit(s) may be a CPU, an ASIC semiconductor chip, a semiconductor chip, a logical unit, a digital processor, an analog processor, an FPGA, or any processor that is capable of performing logical and arithmetic functions. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc. A processing unit(s) may be realized by virtualization and maybe a virtual processing unit(s) including a virtual processing unit in a cloud-based instance.

An end-to-end connection may use a connection-oriented protocol, such as TCP, or a connectionless protocol, such as User Datagram Protocol (UDP), to transmit packets. Well-known protocols for deploying end-to-end connections include Layer 2 Tunnelling Protocol (L2TP), secure shell (SSH) protocol, Multi-protocol Label Switching (MPLS), and Microsoft's Point-to-Point Tunnelling Protocol (PPTP). A connection connected to a network interface is in the form of optical fiber, Ethernet, ATM, Frame Relay, T1/E1. IPv4, IPv6, wireless technologies, Wi-Fi, WiMax, High-Speed Packet Access (HSPA) technology, 3GPP, Long Term Evolution (LTE), or the like.

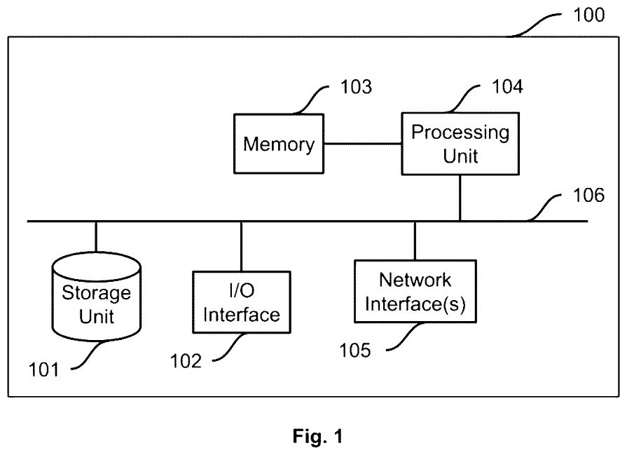

FIG. 1 is a schematic block diagram of an exemplary network device 100 according to the embodiments of the present invention. Network device 100 comprises at least one storage unit 101, at least one I/O interface 102, at least one memory 103, at least one processing unit 104, and more than one network interface 105. Storage unit 101 may contain computer program instructions that are executable by processing unit 104 in order to implement one or more aspects of the present disclosure. Processing unit 104 and memory 103 are connected to each other directly. System bus 106 connects processing unit 104 directly or indirectly to at least one storage unit 101, at least one I/O interface 102, and more than one network interface 105.

In another embodiment, network device 100 may further comprise at least one SIM interface 107 and at least one wireless communication module (WCM) 108 with at least one antenna 109. A SIM or an electronic SIM is capable of housing in or coupled to a SIM interface of at least one SIM interface 107, and establishing a WAN connection through at least one WCM 108 with at least one antenna 109.

Network device 100 may connect to a wired or wireless access network through at least one network interface 105. The wired or wireless access network may carry one or more network protocol data. The wired access network may be implemented by using Ethernet, fiber optic, cable, DSL, frame relay, token ring, serial bus, USB, Firewire, PCI, or any material that can pass information. A wireless access network may be implemented by using infrared, LTE, 5G, Low Earth Orbit (LEO) satellite, HSPA, HSPA+, WiMax, GPRS, EDGE, GSM, CDMA, Wi-Fi, CDMA2000, WCDMA, TD-SCDMA, BLUETOOTH, WiBRO, Evolution-Data Optimized (EV-DO); Digital Enhanced Cordless Telecommunications (DECT); Digital AMPS (IS-136/TDMA); Integrated Digital Enhanced (iDEN) or any other wireless technologies. A wide area network (WAN) connection may be established over an access network to connect two networks.

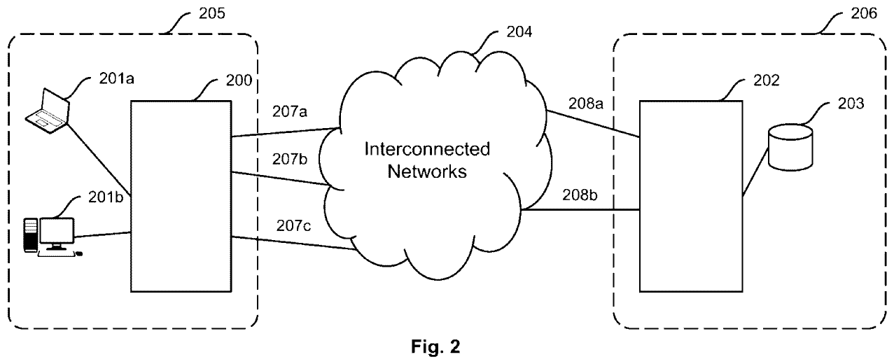

FIG. 2 is a network diagram according to various embodiments of the present invention. Network device 200 and network device 202 are similar to network device 100 illustrated in FIG. 1. Network device 200 and network device 202 are located in site 205 and site 206 respectively. Network devices 200 and 202 may be embodied as multi-WAN network devices that support aggregating the bandwidth of multiple WAN-to-WAN connections. Network devices 200 and 202 are connected via interconnected network 204. Interconnected network 204 is an interconnected network that may comprise a local area network (LAN), such as a company Intranet, a metropolitan area network (MAN), or a WAN, such as the Internet or the World Wide Web.

At site 205, laptop 201a and desktop 201b are connected to network device 200 through the first network interface of network device 200. At site 206, server 203 is connected to network device 202 through a first network interface of network device 202.

In one embodiment, site 205 and site 206 are situated in the same region or country, such as the United States.

In another embodiment, site 205 and site 206 are situated in different regions or countries, such as the United States and Singapore respectively.

Network device 200 comprises at least one network interface that is capable of connecting to access networks, and network device 202 comprises at least one network interface that is capable of connecting to access networks. Access networks are networks through which access to interconnected networks 204 can be achieved. Laptop 201a and desktop 201b may be connected to network device 200 through the first network interfaces of network device 200. Similarly, server 203 may be connected to network device 202 through the first network interface of network device 202. Server 203 may be located in the LAN of network device 202.

In one embodiment, each of the at least one network interface of network device 200 and each of the at least one network interface of network device 202 may be a WAN interface. In one embodiment, the WAN interface may be implemented using a WCM and antenna, which is capable of connecting with a base station of the internet service provider.

In one variant, the antenna is a non-omnidirectional antenna for use with an LEO constellation.

In another embodiment, each of the at least one network interface of network device 200 and each of the at least one network interface of network device 202 may be a LAN interface. Each of the network devices 200 and 202 is capable of connecting to the interconnected network through a LAN interface by configuring the LAN interface as a WAN interface.

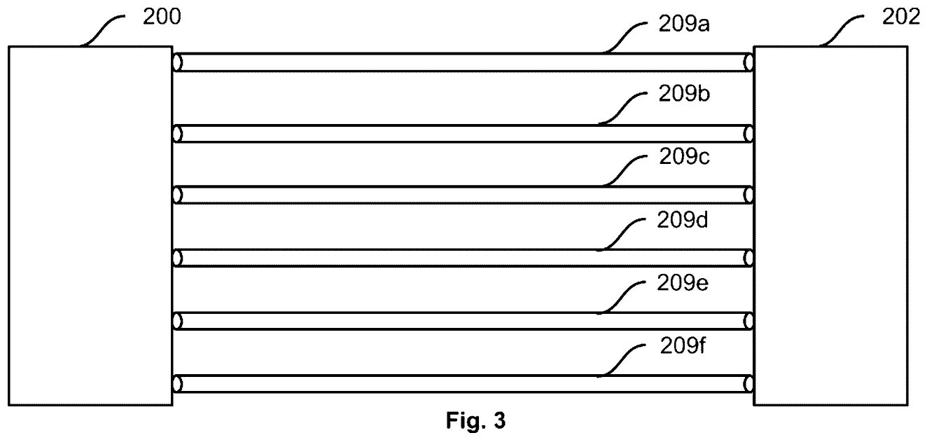

Network device 200 may comprise three network interfaces capable of connecting to three access networks 207a-c, and network device 202 may comprise two network interfaces capable of connecting to two access networks 208a-b. Hence, six connections may be created through access networks 207a-c and 208a-b. However, these configurations may vary according to the desired network device and configuration. There is no restriction on the number of network interfaces of network devices 200 and 202, the designation of three network interfaces of network device 200 and two network interfaces of network device 202 is made for illustrative purposes only. The connections are established between network device 200 and network device 202 as illustrated in FIG. 3.

FIG. 3 illustrates the connections established between two network devices according to the exemplary embodiments of the present invention. FIG. 3 should be viewed in conjunction with FIG. 2 for illustrative purposes. At least one end-to-end connection may be established between a host within the same LAN of network device 200 and a host within the same LAN of network device 202 via at least one of the connections established between network devices 200 and 202. Each connection may be established via a network interface of network device 200 and a network interface of network device 202. If network device 200 comprises M network interfaces and network device 202 comprises N network interface, then M*N connections are established between network devices 200 and 202.

For example, if network device 200 comprises three network interfaces, and network device 202 comprises two network interfaces, then six connections 209a-f may be created when connections are established between the network interfaces of network devices 200 and 202, as illustrated in FIG. 3. The at least one end-to-end connection established between laptop 201a and server 203 may be established via at least one of the six connections.

The value of M and N may vary according to desired devices and configurations. There is no limitation on the number of M and N, M and N may be any positive integer such that the summation of M and N is equal to or greater than three. In another example, it is possible that M is equal to one and N is equal to two, and two connections are thereby created.

Access networks of network devices 200 and 202 are access connections for communicating information within interconnected network 204 between sites 205 and 206.

Connections 209a-f may have similar or different bandwidth capabilities. Further, access networks of network devices 200 and 202 may comprise different types of WAN connections, such as Wi-Fi, cable, DSL, 3G, 4G, LTE, 5G, satellite connections, or the like. It is also noted that sites 205 and 206 may be thought of as both the sender and the receiver, and discussions regarding the functionality of either site may be implemented on the other site. Connections 209a-f correspond to a unique permutation of the access networks of site 205 and the access networks of site 206.

In one embodiment, an aggregated connection is formed between network devices 200 and 202. The plurality of connections may be aggregated, combined, or bonded together to form one aggregated connection. One skilled in the arts would appreciate that there are myriad ways to aggregate, combine, or bond the plurality of connections to form one aggregated connection. An aggregated connection is perceived as one connection by sessions or applications that are using it. An aggregated connection can be perceived as a tunnel, a virtual private network (VPN) connection, or a connection-oriented connection.

For example, the aggregated connection is an aggregation of a plurality of connections, such as connections 209a-f, established between network devices 200 and 202. The aggregated connection may be created when a TCP session is created. For example, when laptop 201a attempts to connect with server 203, the aggregated connection is established between laptop 201a and server 203 through network devices 200 and 202.

In another example, an aggregated connection is a VPN tunnel, comprising a plurality of tunnels, and each tunnel is established between the network interfaces of network devices 200 and 202.

In one example, the aggregated connection is a TCP connection.

In another example, the aggregated connection is a UDP connection.

For illustrative purposes, a TCP session is created when laptop 201a attempts to establish a connection with server 203 through network devices 200 and 202. When the TCP session is created, network device 200 may transmit the data packets through a connection via the network interface of network device 200 and the network interface of network device 202. At this time, the congestion control process begins.

In one embodiment, data packets are transmitted through the connections of the aggregated connection according to a weight assigned to each connection of the aggregated connection, and a default weight is determined for each connection of the aggregated connection. The default weight is initially assigned to each connection by default before any modification or change in the weight of a connection is applied.

In one example, a default weight is determined and/or assigned for each of the access networks according to the exchanged uplink and downlink bandwidth data of each of the access networks.

In another example, a default weight is determined and/or assigned for each of the access networks according to criteria(s) that may affect the performance of the access networks.

Suppose site 205's downlink bandwidths of access networks 1 to a are d1, d2, . . . , dm, and site 206's uplink bandwidths of access networks 1 to b are u1, u2, . . . , un; a default weight for a connection between site 205's access network x and site 104's access network y may be defined as DW (x,y), where DW (x,y)=dx·uy.

The default weight may be calculated with the above method. If uplink/downlink bandwidths of the three access networks of network device 200 are 10 M/6 M, 8 M/4 M, and 6 M/6 M, and uplink/downlink bandwidths of two access networks of network device 202 are 7 M/5 M and 9 M/3 M, the default weights for each connection will be as follows:

| Network device 200 | Network device 202 |
|---|---|
| DW(1,1) = 6M*7M = 42M | DW(1,1) = 5M*10M = 50M |
| DW(1,2) = 6M*9M = 54M | DW(1,2) = 5M*8M = 40M |
| DW(2,1) = 4M*7M = 28M | DW(1,3) = 5M*6M = 30M |
| DW(2,2) = 4M*9M = 36M | DW(2,1) = 3M*10M = 30M |
| DW(3,1) = 6M*7M = 42M | DW(2,2) = 3M*8M = 24M |
| DW(3,2) = 6M*9M = 54M | DW(2,3) = 3M*6M = 18M |

There are myriad ways for calculating the default weight, the method mentioned above is for illustrative purposes only.

In another embodiment, data packets are transmitted through a group of connections of the aggregated connection. Each connection of the aggregated connection is classified into different groups of connections and data is transmitted through the connections based, at least in part, on the groups the connections are classified into. There is no limitation on the number of groups that a connection will be classified into, it is possible for a connection to be classified into more than one group of connections depending on the criteria of each group of connections.

Mainly, two parameters, size of the congestion window (cwnd) and slow start threshold (ssthresh), are used to control the congestion of the established connection. The established connection is controlled by the network device by controlling the rate of data packet transmission of the connection in four stages in the congestion control process, namely: (i) a slow start stage, (ii) a congestion avoidance stage, (iii) a fast retransmit stage, and (iv) a fast recovery stage.

In one preferred embodiment, after a session is created, the congestion control process begins before a three-way handshake.

In another embodiment, after the session is created, the congestion control process begins after the three-way handshake.

When network device 200 receives a first data packet from laptop 201a, which is to be transmitted to server 203. Server 203 is locally connected to network device 202 over a LAN. Network device 200 may send the data packet to network device 202 through the established aggregated connection. At this time, the size of the congestion window becomes 1. One skilled in the art should know that more data packets may be received by network device 200 after receiving the first data packet. If more data packets are received at network device 200 from laptop 201a that are destined for server 203, network device 200 may send out the subsequent data packets after receiving the acknowledgment of the previous data packet based on the size of the congestion window.

When the first data packet is successfully received by server 203, network device 200 may then receive an acknowledgment of the first data packet from server 203 through network device 202, and the size of the congestion window is increased until the slow start threshold is reached. For illustrative purposes, the size of the congestion window is increased by doubling the original size (new cwnd=cwnd*2) after an acknowledgment is received.

When network device 200 successfully receives the acknowledgment of the first data packet from server 203 through network device 202, network device 200 may attempt to transmit a second and a third data packets to server 203 through network device 202, and the size of the congestion window becomes 2. The second and third data packets are received from laptop 201a. When network device 200 successfully receives the acknowledgment of the second and the third data packets from server 203 through network device 202, network device 200 may attempt to transmit the fourth, fifth, sixth, and seventh data packets to server 203 through network device 202, and the size of the congestion window becomes 4. Therefore, the size of the congestion window increases exponentially until the slow start threshold is reached (i.e. cwnd=ssthresh).

There is no limitation that the size of the congestion window must increase exponentially. Any other suitable algorithm for increasing the size of the congestion window may be applied. In another example, the size of the congestion window is increased by 2 (new cwnd=cwnd+2) after an acknowledgment is received.

When the size of the congestion window reaches the slow start threshold, the data packet transmission enters into the congestion avoidance stage from the slow start stage to fix the network meltdown. In the congestion avoidance stage, the size of the congestion window no longer increases in the foregoing exponential manner but increases linearly. After a period of time, the TCP transmission rate exceeds the network connection capacity and thus inducing packet loss. However, it is possible for packet loss or time-out to occur before the congestion avoidance stage, i.e., in the slow start stage.

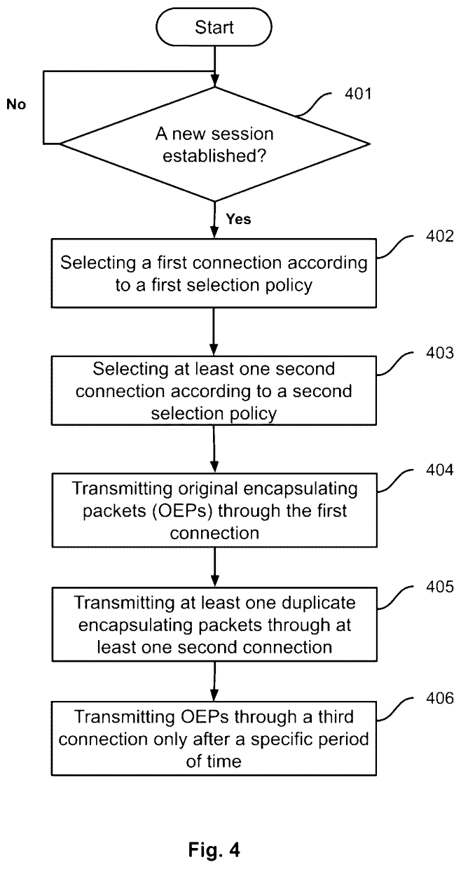

FIG. 4 is the process flow diagram illustrating processes performed at the network device during the slow start stage according to one of the embodiments of the present invention.

When a network device receives data packets from a host, such as laptop 201a, the process begins for each of the received data packets.

In process 401, network device 200 may determine if a new session is established. The session may be a TCP session or a UDP session.

In one embodiment, the network device determines if a new session is established by identifying whether a data packet received belongs to a new session or not. For example, to determine whether the data packet received is the first data packet of the new session, the processing unit of network device 200 may read one or more of the following information included in the header of the data packet received: a source address, source port, destination address, destination port, and protocol.

When the data packet received is not the first data packet of a new session, the network device will route the data packet received through a pre-selected connection and continue to apply determination process 401 on the next received data packet. The pre-selected connection may be initially selected when the first data packet belonging to the data session of the data packet received was determined. In one variant, when the data packet received is not the first data packet of a new session, the network device determines whether the data packet received is the last data packet of an active session. If the data packet received is the last data packet of the active session, it will be obvious that the next data packet to be received will be the first data packet of a new session. As such, the network device may perform processes 402 and 403 in advance, prior to receiving the first data packet of a new session. Thus, when the next data packet is received, the network device will not be required to perform processes 401-403 and can skip to process 404 instead. This will significantly facilitate the present invention to boost data session establishment and reduce the processing load of a new data session establishment phase. Whether a data packet received is the last data packet of the active session or not may be determined based on one or more of, a source address, source port, destination address, destination port, and/or protocol of the received data packet.

On the other hand, when the data packet is the first data packet of the new session, the network device may perform process 402 and the subsequent processes.

In one variant, network device 200 may determine whether a data packet received is the second or the third data packet of the new session instead of the first. When the data packet received is the second or third data packet of the new session, the network device may perform process 402 and the subsequent processes.

In process 402, network device 200 may select a first connection for transmitting the data packets belonging to the new session. The first connection is a connection established between the network interface of network device 200 and the network interface of network device 202. The first connection is selected according to a first selection policy.

In process 403, network device 200 may select at least one second connection according to a second selection policy. The at least one second connection is at least one connection other than the first connection established between the network interface of network device 200 and the network interface of network device 202.

The first and second selection policies are selected from one or more of the following: weight balance, least used, and lowest latency and priority. Therefore, data packets can be transmitted in a way such that the likelihood of packet loss during the slow start period can be reduced.

In one embodiment, the first selection policy is the same as the second selection policy.

In another embodiment, the first selection policy is different from the second selection policy.

In one example, if “weight balance” is applied for selecting the connection(s) at network device 200, data packets are assigned to be transmitted through the connections according to the weight of each connection of the aggregated connection. The weight may be the default weight calculated for each connection as mentioned above. For illustrative purposes, the weight of each connection of the aggregated connection is bandwidth-dependent, and the default weight is calculated according to the bandwidth of each connection. During the transmission of data packets through the plurality of connections from network device 200 to network device 202, the bandwidth of each connection of the plurality of connections may vary, and therefore the weight may also vary. A network device may transmit data packets through various connections according to the variance of the weight of each connection of the plurality of connections.

In another example, if “least used” is applied for selecting the connection(s) at network device 200, data packets are assigned to be transmitted through the connections according to the traffic of each connection of the aggregated connection. If there are more than one available connection, more data packets are preferred to be transmitted through the connection with the least traffic of the aggregated connection.

In another example, if “latency” is applied for selecting the connection(s) at network device 200, data packets are assigned to be transmitted through the connections according to the latency of each connection of the aggregated connection. If there are two available connections with the latency of 100 ms and 40 ms respectively, more data packets are preferred to be transmitted through the connection having 40 ms latency, i.e., the connection with lower latency.

In another example, if “priority” is applied for selecting the connection(s) at network device 200, data packets are assigned to be transmitted through the connections according to the priority of each connection of the aggregated connection. The priority may be assigned by a user or an administrator according to the requirement or their actual needs. During the transmission of data packets through the plurality of connections from network device 200 to network device 202, data packets are preferred to be transmitted through a connection with the highest priority. If the connection with the highest priority is not available at a point, then the connection with the next highest priority is preferred.

The user or the administrator may configure the first selection policy and the second selection policy of the network device 200 by sending configurations locally or remotely through a web interface, an application programming interface (API), a command line interface, or a console.

In one variant, more than one first selection policy and/or more than one second selection policy may be available at the same time. For example, priority is applied for selecting connection(s) when the data packets are transmitted to a specific destination port, while weight balance is applied when the data packets are transmitted from another specific destination port. The user or the administrator is capable of configuring the priority of the policies to be applied such that there is no conflict between the applied policies.

In process 404, network device 200 may transmit original encapsulating packets (OEPs) through the first connection. The OEPs encapsulate the data packets, and each of the OEPs has an original encapsulating packet global sequence number (OEP-GSN).

In process 405, network device 200 may transmit at least one duplicate encapsulating packet (DEP) through at least one second connection within a specific period of time. The at least one DEP encapsulates at least one of the data packet. Each DEP has a duplicate encapsulating packet global sequence number (DEP-GSN), which is stored in a header of the DEP. Details of the OEP and the DEP will be discussed below.

It would be known to those skilled in the art that in wireless communications, the quality of packet transmission may be unpredictable and latency may be high in some instances. The packet drop rate may be high as well. Transmitting DEPs increases the chances of the data being received by network device 202, in case the OEPs are dropped. However, bandwidth usage may be significantly increased by the transmission of DEPs. Therefore, the data packets will only be duplicated and transmitted for a specific period of time only.

In process 406, after the specific period of time, network device 200 may continue to transmit the OEPs through a third connection, but no longer transmit at least one DEPs through the at least one second connection.

Typically, process 404 and process 405 are performed after the slow start stage has begun. During the slow start stage, the amount of data packets transmitted over the connections is exponentially increased. By transmitting the data packets over the connections of the aggregated connection during the slow start stage, the chance of packet loss and latency occurrences can be reduced, and the rate of transmitting data packets through the aggregated connection established between network devices 200 and 202 can be maximized.

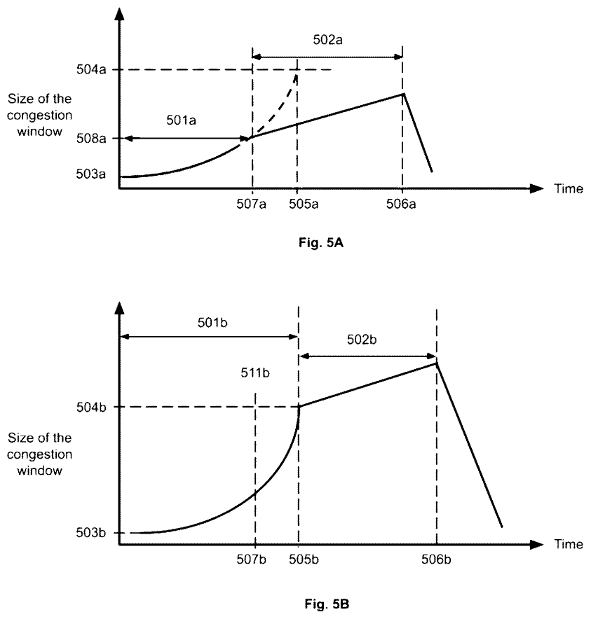

However, if packet loss occurs during the slow start stage, then the exponential increase of the number of data packets transmitted may be interrupted for a specific period of time and the congestion control process moves to the congestion avoidance stage as illustrated in FIG. 5B.

After a specific period of time counting from the start of the slow start stage, the first selection policy and/or the second selection policy is/are no longer applied for transmitting the data packets through the one or more connections established between network device 200 and network device 202. Instead, network device 200 may transmit the data packets through the third connection established between network device 200 and network device 202.

In one embodiment, the third connection is the same as the first connection selected at process 402.

In another embodiment, the third connection is different from the first connection selected at process 402. Network device 200 may select another connection for transmitting the data packets by any means, such as the second selection policy.

The factors for determining the specific period of time comprise one or more of the following: the duration of the slow start period, bandwidth, latency, and any factors that may affect data transmission. There is no limitation on how the specific period of time is determined. The specific period of time may be any time between the beginning and the end of the slow start stage.

In one example, the specific period of time is from 2 seconds to 4 seconds counted from the beginning of the slow start stage.

In another example, the specific period of time is 3 seconds counted from the beginning of the slow start stage.

FIG. 5A shows the relationship between the size of the congestion window versus the time for transmitting data packets of a TCP session according to a conventional congestion control process implementation. The data packets are transmitted through a connection of the plurality of connections established between network devices 200 and 202. There is no policy applied for controlling the transmission of data packets through the aggregated connection, the data packets may be transmitted through a connection of the aggregated connection. As mentioned previously, four stages are included in the congestion control process, but only slow start stage 501a and congestion avoidance stage 502a are shown in FIG. 5A for illustrating the embodiment of the present invention.

During slow start stage 501a, the size of the congestion window continues to grow exponentially from the initial size of the congestion window. For illustrative purposes, the size of the congestion window continues to grow exponentially from the initial size of the congestion window 503a to a slow start threshold 504a when the time for transmitting data packets of a TCP session reaches 505a. However, it is possible for packet loss to occur during the slow start stage.

When packet loss occurs during the slow start stage, since congestion is detected, the congestion control process moves from slow start stage 501a to congestion avoidance stage 502a, even if the congestion window size is not reached by slow start threshold 504a. For example, when packet loss occurs at 507a, the congestion control process moves from slow start stage 501a to congestion avoidance stage 502a, even if the congestion window size reaches 508a only instead of 504a.

During congestion avoidance stage 502a, the congestion window size can only be increased linearly until there is an indication that duplicated acknowledgments (ACKs) have been received. In one embodiment, a congestion avoidance algorithm may be applied for controlling the congestion.

Therefore, network device 200 may send out subsequent data packets based on the congestion avoidance algorithm applied. The congestion avoidance algorithm may be selected from one or more of the following: TCP Reno, TCP Vegas, TCP-Fast, Compound TCP, TCP Veno, TCP Westwood, TCP Cubic, and TCP BIC.

There is no limitation on the congestion avoidance algorithm applied for controlling the congestion, any congestion avoidance algorithm that includes various aspects of an additive increase/multiplicative decrease (AIMD) scheme can be applied.

For illustrative purposes, at 506a, duplicated ACKs have been received at network device 200. The size of the congestion window is therefore reset to the initial size of the congestion window 503a, and the process of growing the size of the congestion window begins again (e.g. the size of the congestion window is reset to 1), and the slow start threshold is reduced (e.g. ssthresh=current cwnd/2). There is no limitation on the size of the congestion window after reset, which may vary according to the congestion avoidance algorithm applied.

In order to reduce the packet loss during the slow start stage illustrated in FIG. 5A, the methods proposed in the present invention are applied during the slow start stage according to the embodiments of the present invention. As a result, the relationship between the size of the congestion window versus the time for transmitting data packets of a TCP session shown in FIG. 5B is different from that shown in FIG. 5A.

FIG. 5B shows the relationship between the size of the congestion window versus the time for transmitting data packets of a TCP session according to the present congestion control process implementation with packet loss during the slow start stage. FIG. 5B should be viewed in conjunction with FIG. 2 and compared with FIG. 5A. The data packets are transmitted through connections of the plurality of connections established between network devices 200 and 202. Similar to FIG. 5A, only slow start stage 501b and congestion avoidance stage 502b are shown in FIG. 5B for illustrating the embodiment of the present invention.

In one variant, the plurality of connections are aggregated as an aggregated connection.

When data packets of a session begin to be transmitted, the congestion control process begins and enters slow start stage 501b. Network device 200 may transmit the OEPs and DEPs through the plurality of connections established between network devices 200 and 202 once the first data packet of the session are determined.

During slow start stage 501b, the size of the congestion window continues to grow exponentially from an initial size of the congestion window similar to the slow start stage 501a illustrated in FIG. 5A.

For illustrative purposes, the size of the congestion window continues to grow exponentially from initial size of the congestion window 503b to a slow start threshold 504b when the time for transmitting data packets of a TCP session reaches 505b. However, it is possible for packet loss to occur during the slow start stage.

Since the method illustrated in FIG. 4 is applied through the plurality of connections established between network devices 200 and 202, packet loss may be reduced. For example, when a data packet is transmitted through the plurality of connections at network device 200, the data packets are encapsulated as an OEP and at least one DEP respectively. Network device 200 may transmit the OEP through the first connection, and transmit the at least one DEP through at least one second connection within a specific period of time. Therefore, the chances of the data being received by network device 202 are increased by the transmission of both OEP and DEP concurrently through the plurality of connections.

For example, a data packet is transmitted from laptop 201a to server 203 by transmitting an OEP through connection 209a and a DEP through connection 209c, and packet loss may occur when transmitting the OEP through connection 209a. It is possible that the DEP is successfully received by network device 202 by transmission of the DEP through connection 209c. Therefore, an acknowledgment of the data packet is received from server 203 through network device 202. As a result, the size of the congestion window will continue to grow exponentially and the congestion control process will not switch from slow start stage 501b to congestion avoidance stage 502b. This will extend the time of slow start stage 501b.

Therefore, according to the technique disclosed in FIG. 5B the congestion avoidance stage will start at a higher congestion window size, as compared with the conventional techniques disclosed in FIG. 5A. Achieving a higher congestion window size at slow start stage will increase the probability of congestion window size to reach the slow start threshold; whereas according to the conventional technique, illustrated in FIG. 5A, congestion control process may trigger congestion avoidance stage before reaching the slow start threshold.

When the congestion window size reaches slow start threshold 504b, the congestion control process switches from slow start stage 501b to congestion avoidance stage 502b. As a higher congestion window size is reachable according to the present invention, slow start threshold 504b may also be set at a higher level. This will help to increase the data transmission bandwidth very fast.

During congestion avoidance stage 502b, the congestion window size increases linearly until there is an indication that duplicated ACKs have been received. Compared with FIG. 5A, more data packets can be transmitted during the congestion avoidance stage.

To monitor the bandwidth of the various connections 209a-f, some embodiments of the present invention encapsulate each transmitted IP packet with various information.

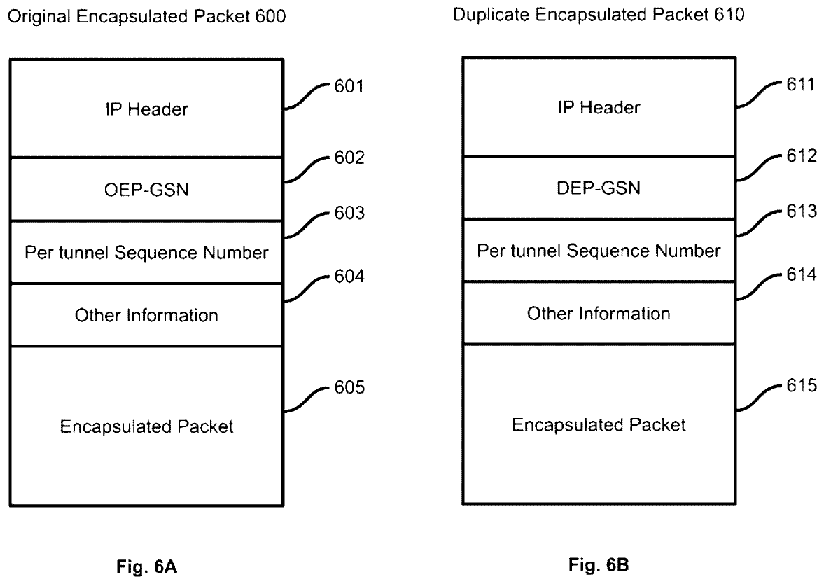

FIG. 6A illustrates the structure of an OEP according to various embodiments. OEP 600 is an encapsulating packet that encapsulates an encapsulated data packet with various information for data packet transmission. OEP 600 comprises IP header 601, OEP-GSN 602, per tunnel sequence number 603, other information 604, and encapsulated packet 605. OEP-GSN 602 holds the OEP-GSN of OEP 600.

Per tunnel sequence number 603 may be a 32-bit field that represents a sequence number that is assigned to each packet routed to a particular tunnel. Advanced Encryption Standard (AES) encrypted payload field may be utilized to convey the payload of the IP packet. AES encryption may be applied for higher security of the payload in order to prevent attacks from third parties.

IP header 601 may comprise one or more of the following: the version field, the protocol type field, the tunnel ID field, and the global sequence number field. Other information 604 may comprise the AES initialization vector field and the tunnel ID field.

The version field may contain information about the protocol version being utilized and the protocol type field may contain the protocol type of the payload packet. In general, the value of this field will correspond to the Ethernet protocol type for the packet. However, additional values may be defined in other documents. The tunnel ID field may be a 32-bit field and may contain an identifier to identify the current tunnel of the IP packet.

The AES initialization vector field may be a 32-bit field and may contain an initialization vector for AES encryption. The global sequence number field may be a 32-bit field and may contain a sequence number that is utilized to re-sequence each of the packets for various sessions into the proper order when they have emerged from their respective tunnels.

In one variant, per tunnel sequence number 603 and the tunnel ID field may be used for comparing tunnel performance and redistributing packets according to the tunnel performance.

In another variant, per tunnel sequence number 603 may be a session number or flow number.

In another variant, per tunnel sequence number 603 may be optional. When per tunnel sequence number 603 and the tunnel ID field are not included, a database may be required to be maintained in order to store information regarding which tunnel was used for transmitting encapsulating packets of which GSN. By performing a lookup in the database, the tunnel performances may be compared. Therefore, including per tunnel sequence number 603 and the tunnel ID field in the OEP may assist in determining latency without having to maintain and lookup a database of all GSNs.

In one variant, OEP-GSN 602, per tunnel sequence number 603, and other information 604 are contained in an option field of IP header 601, and encapsulated packet 605 is contained within the AES encrypted payload field. The benefit of including OEP-GSN 602, per tunnel sequence number 603, and other information 604 within the option field of IP header 601 is that OEP 600 need not be decapsulated in order to retrieve the information contained in these fields, which may significantly reduce the processing time. However, when OEP 600 is transmitted through the tunnel, routers and devices, IP header 601 may be changed, and information in these fields may therefore be lost if they are included within the option field of IP header 601. Therefore, alternatively, OEP-GSN 602, per tunnel sequence number 603, other information 604, and encapsulated packet 605 may all be comprised within AES encrypted payload field 612, so that the information is retained when OEP 600 passes through routers and devices which may change IP header 601.

FIG. 6B illustrates the structure of a DEP according to various embodiments. DEP 610 is an encapsulating packet that encapsulates an encapsulated data packet with various information for data packet transmission. Similar to OEP 600, DEP 610 comprises IP header 611, DEP-GSN 612, per tunnel sequence number 613, other information 614, and encapsulated packet 615.

OEP-GSN 602 and DEP-GSN 612 may be identical. Encapsulated packets 605 and 615 may be identical, such that OEP 600 and DEP 610 encapsulate the same data packet, which becomes encapsulated packets 605 and 615 respectively. When network device 200 generates at least one DEP 610 for transmission, the payload, i.e., the encapsulated packet, is the same as that of the OEP 600. Since OEP 600 and DEP 610 have the same contents, their global sequence numbers are also the same. Since DEP 610 comprises the same encapsulated packet as OEP 600, DEP 610 may be used to recreate the information in OEP 600 in case OEP 600 is lost, dropped, or late during transmission, and DEP 610 is received before OEP 600 is received.

1. A method for transmitting data packets at a network device, comprising:
a. determining if a data packet belonging to a new session is received;
b. selecting a first connection according to a first selection policy;
c. selecting at least one second connection according to a second selection policy;
d. transmitting each of original encapsulating packets (OEPs) through the first connection;
e. transmitting each of at least one duplicate encapsulating packets (DEPs) through the at least one second connection within a specific period of time; and
f. transmitting each of OEPs through a third connection, and no longer transmit the at least one DEPs;
wherein the data packet is one of the data packets received from a host; and
wherein the specific period of time is a period of time within the slow start stage.

2. The method of claim 1, wherein the OEPs encapsulate the data packets.

3. The method of claim 1, wherein each of the OEPs has an original encapsulating packet global sequence number (OEP-GSN).

4. The method of claim 1, wherein the specific period of time is 3 seconds counted from the beginning of the slow start stage.

5. The method of claim 1, wherein the at least one DEP encapsulates data packet information based on at least one of the data packets.

6. The method of claim 1, wherein each of the at least one DEP has a duplicate encapsulating packet global sequence number (DEP-GSN).

7. The method of claim 1, wherein the OEP-GSN is stored in a header of each of the OEPs and the DEP-GSN is stored in a header of each of the at least one DEP.

8. The method of claim 1, wherein the first selection policy and the second selection are selected from one or more of the following: weight balance, least used, and lowest latency and priority.

9. The method of claim 1, wherein the third connection is the same as the first connection.

10. The method of claim 1, wherein the third connection is different from the first connection.

11. A network device, comprising:
a processing unit;
at least one storage unit;
more than one network interface;
at least one non-transitory computer readable storage medium; wherein the at least one non-transitory computer readable storage medium for storing program instructions executable by the at least one processing unit for:
a. determining if a data packet belonging to a new session is received;
b. selecting a first connection according to a first selection policy;
c. selecting at least one second connection according to a second selection policy;
d. transmitting each of original encapsulating packets (OEPs) through the first connection;
e. transmitting each of at least one duplicate encapsulating packets (DEPs) through the at least one second connection within a specific period of time; and
f. transmitting each of OEPs through a third connection, and no longer transmit the at least one DEPs;
wherein the data packet is one of the data packets received from a host; and
wherein the specific period of time is a period of time within the slow start stage.

12. The network device of claim 11, wherein the OEPs encapsulate the data packets.

13. The network device of claim 11, wherein each of the OEPs has an original encapsulating packet global sequence number (OEP-GSN).

14. The network device of claim 11, wherein the specific period of time is 3 seconds counted from the beginning of the slow start stage.

15. The network device of claim 11, wherein the at least one DEP encapsulates data packet information based on at least one of the data packets.

16. The network device of claim 11, wherein each of the at least one DEP has a duplicate encapsulating packet global sequence number (DEP-GSN).

17. The network device of claim 11, wherein the OEP-GSN is stored in a header of each of the OEPs and the DEP-GSN is stored in a header of each of the at least one DEP.

18. The network device of claim 11, wherein the first selection policy and the second selection are selected from one or more of the following: weight balance, least used, and lowest latency and priority.

19. The network device of claim 11, wherein the third connection is the same as the first connection.

20. The network device of claim 11, wherein the third connection is different from the first connection.
